(19) United States
(12) Patent Application Publication
(10) Pub. No.: US 2007/0247999 A1
(43) Pub. Date: Oct. 25, 2007

(54) Multi-layered optical recording medium, information recording method, and information reproduction method

(76) Inventors: Masaki Mukoh, Tokyo (JP); Takeshi Maeda, Koganei (JP); Akemi Hirotsune, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/513,363

(22) Filed: Aug. 31, 2006

(30) Foreign Application Priority Data
Apr. 24, 2006 (JP) 2006-118873

(51) Int. Cl. G11B 3/70

(52) U.S. Cl. 369/276

(57) ABSTRACT

High-speed and high-density recording of a layer-selected optical disc are enabled with a small number of electrodes. A plurality of recording films that are independently selectable are disposed between a pair of electrodes 3 and 8. The recording films are controlled individually in terms of a threshold of voltage required for coloration and electric characteristics. A desired layer can be selected by changing the voltage applied between the pair of electrodes.

### CLAIM OF PRIORITY

The present application claims priority from Japanese application JP 2006-118873 filed on Apr. 24, 2006, the content of which is hereby incorporated by reference into this application.

### BACKGROUND OF THE INVENTION

1. Field of the Invention

The invention relates to a multi-layered optical recording medium for optical recording and reproduction of information, and to a method for recording and reproducing information on the medium.

2. Background Art

The major features of optical discs are that the recording media (discs) can be removed from the recording and reproduction apparatus and that they are inexpensive. It is desirable that higher speed and density are achieved in optical disc apparatuses without compromising these features.

Various principles are known for recording information by irradiating a recording film with light. Examples of optical discs now in practical application in which organic material is used in a recording layer include CD-R's and DVD-R's. In these discs, the recording layer that includes a pigment that has absorption at the wavelength of the recording light source is irradiated with laser, whereby the recording layer is transformed for recording purposes. A principle that is based on changes in the atomic arrangement caused by heat, such as the phase change (also referred to as phase transition or phase transformation) of a film material, is applied to information recording media that can be rewritten a number of times. The basic structure of a phase-change optical disc consists of a substrate on which a protection layer, a recording film such as Ge—Sb—Te, a protection layer, and a reflecting layer are stacked. Phase-change optical discs having up to four recording film layers are now under development. However, in the conventional multi-layered recording medium, there is a tradeoff between the transmittance of each layer and the recording sensitivity when there are three layers or more. Thus, it has been unavoidable to sacrifice either the quality of the reproduction signal or the recording sensitivity. It has also been necessary to provide a layer-to-layer interval of approximately 20 μm or more so as to prevent the adverse effect of the information recorded in an adjacent layer (interlayer crosstalk), thereby making the manufacture of the recording medium difficult as the number of layers increases.

JP Patent Publication (Kokai) No. 2003-346378 A discloses an optical disc of the type in which an electrochromic material is used and a layer is selected by voltage. In order to supply a voltage to a rotating disc via a static portion of the recording and reproduction apparatus, a voltage transmission mechanism is disposed at or near the rotating axis. JP Patent Publication (Kokai) Nos. 2003-346378 A and 2004-310912 A describe a voltage transmission mechanism for supplying voltage to the layer-selected optical disc.

An electrochromic device is comprised of a lower transparent electrode, an electrochromic film, a solid electrolyte film, and an upper transparent electrode. When a voltage is applied between the upper and lower transparent electrodes, H⁺ (proton) or a cation in the solid electrolyte film enters the electrochromic film, whereby the chemical structure of the electrochromic material is altered and the film becomes colored.

Patent Document 1: JP Patent Publication (Kokai) No. 2003-346378 A

Patent Document 2: JP Patent Publication (Kokai) No. 2004-310912 A

### SUMMARY OF THE INVENTION

The optical disc in which a layer is selected by voltage has the advantage that the number of recording layers can be greatly increased. Thus, in the conventional voltage transmission mechanism, as many pin electrodes as there are recording layers are provided on the disc and in the apparatus so that a layer can be selected by switching. It is expected that in the future, the arrangement of such a large number of pins would be a problem as the number of layers further increases. In response, the following two countermeasures are being contemplated. One is a method whereby the electrodes are greatly reduced in size so as to cope with the increase in the number of layers. In this method, high positioning accuracy is required for the one-to-one correspondence with which the fine electrodes need to be fixed on both the disc and apparatus side. Fine electrode manufacturing and wiring techniques are also required. As a result, the cost of the disc and the apparatus increases. Another countermeasure is a method whereby the electrode area is increased so as to cope with the increased number of layers while the size of the electrodes is not changed. In this method, there is no need to microfabricate the electrodes, but the area of the electrode portion increases as the number of electrode increases. Consequently, the recording area (capacity) decreases, which means an increase in the per-bit unit cost of the recording region.

In such layer-selected optical discs, the recording regions that are not selected need to be transparent. However, as the number of recording layers increases, the number of layers of which a single disc is comprised also increases, resulting in a greater influence of absorption per layer and resulting in a decrease in signal intensity.

At ISOM2005, calculated values of optical properties of each film required for the multilayer structure in the layer-selected optical discs using an electrochromic material were noted (“Optical Characteristics for Layer-Selection-type Recordable Optical Disk (LS-R)”, A. Hirotsune et al., ISOM/ODS 2005 Tech. Digest (2005) MC7). In this case, the transparent electrode layer is one of the components of the current optical disc using an electrochromic material that has the greatest absorption and of which it is difficult to reduce absorption in the future. The transparent electrode mainly employs a transparent conductive film such as ITO, and there is a tradeoff between the transmission and conductivity of the transparent conductive film, as will be described below.

In classical theory of electrons, the absorption coefficient α_{f} of free carrier absorption in metals is expressed by the following equation (J. I. Ponkove, “Optical Processes in Semiconductors”):

α_{f}=Nq²λ²/(m*8π²nc³τ) (1)

where N is the carrier density, n is the index of refraction, and τ is the scattering relaxation time.

In semiconductors, since τ has wavelength dependency that varies depending on the mechanism of scattering, α_{f} is expressed by the following equation

α_{f}=Aλ^{1.5}+Bλ^{2.5}+Cλ^{3.5} (2)

where A, B, and C are constants determined by the material. On the other hand, the DC conductivity σ, which determines the sheet resistance, can be expressed by the following equation:

σ=Nqμ (3)

where N is the carrier density, and μ is mobility. Mobility μ can be expressed, in the case of isotropic scattering, as μ=qτ/m*, so that the conductivity σ is expressed by

σ=Nq²τ/m* (4)

where, when it is assumed that τ and τ_{c} of free carrier absorption are the same, the following relationship holds between free carrier absorption and conductivity:

α_{f}=σλ²τ_{c}²/(8π²nc³) (5)

In order to reduce the resistivity of the transparent electrode, it is necessary to raise the absorption (or lower the transmittance). Namely, in the layer-selected optical disc, preferably an increase in capacity is achieved while the aforementioned tradeoff is solved.

It is an object of the invention to solve the aforementioned problems of the prior art and to achieve an increase in recording capacity and carry out layer selection stably.

A multi-layered optical recording medium according to the invention includes a plurality of electrochromic recording layers stacked between a pair of electrodes. The multiple electrochromic recording layers are disposed such that a threshold of an applied voltage required for coloration simply increases or decreases as the distance between a light incident side and the recording layers decreases, or such that a cut-off frequency simply increases or decreases as the distance between a light incident side and the recording layers decreases.

A desired one of the recording layers can be caused to become colored by applying a layer select voltage between the pair of electrodes, wherein the layer select voltage is determined by one or a combination of the voltage value of a DC voltage, application time, the frequency of an AC voltage, and amplitude. When the multi-layered optical recording medium is recorded or reproduced, information can be recorded on or reproduced from a selected and colored recording layer alone.

In accordance with the invention, the number of transparent electrode layers can be reduced as compared to conventional structures, so that the number of electrodes can also be reduced. As the number of layers of which the disc is composed decreases, the transparency of the disc increases and the number of layers that can be stacked increases, whereby the capacity of a single disc can be increased. Furthermore, as the number of electrodes decreases, the modification of both the apparatus and the medium that would be required if the number of electrodes were to increase can be minimized. Based on these features, the invention provides an inexpensive apparatus and medium capable of high-density recording.

### BRIEF DESCRIPTION OF THE DRAWINGS

FIG. 1 shows an electric equivalent circuit model of an electrochromic device according to the invention.

FIG. 2 shows an electric equivalent circuit model of the electrochromic device according to the invention when attention is focused on an electric path.

FIG. 3 shows another example of the electric equivalent circuit model of the electrochromic device when attention is focused on an electric path.

FIG. 4 shows a simulation of the DC-voltage temporal response of electrochromic films having different electric characteristics.

FIG. 5 shows a simulation of the temporal response of electrochromic films having different electric characteristics immediately after the application of a DC voltage.

FIG. 6 is a drawing for the explanation of an example of layer selection based on a change in the DC-voltage application time.

FIG. 7 is a drawing for the explanation of an example of layer selection in which an inverse DC voltage is applied upon elimination of color.

FIG. 8 shows an example of layer selection based on a change in the applied DC voltage.

FIG. 9 is a drawing for the explanation of a method for intermittently applying a DC voltage.

FIG. 10 shows the result of a simulation of the angular velocity dependency of an AC voltage amplitude ratio and phase difference in electrochromic films having different electric characteristics.

FIG. 11 is a drawing for the explanation of layer selection based on a change in the frequency of the applied AC voltage.

FIG. 12 is a drawing for the explanation of layer selection using an AC voltage having an offset.

FIG. 13 is a drawing for the explanation of layer selection using an AC voltage having an offset.

FIG. 14 shows an electric equivalent circuit model of a consecutive stacking of a plurality of electrochromic recording layers.

FIG. 15 shows the structure of an information recording medium according to an embodiment of the invention.

FIG. 16 shows electrodes at a disc holder portion via which the information recording medium is set.

FIG. 17 shows a block diagram illustrating the input and output of signals in an embodiment of the invention.

FIG. 18 shows the structure of information recording medium according to an embodiment of the invention.

FIG. 19 shows the structure of information recording medium according to an embodiment of the invention.

FIG. 20 shows the structure of information recording medium according to an embodiment of the invention.

### DESCRIPTION OF THE PREFERRED EMBODIMENTS OF THE INVENTION

The information recording medium according to the invention is comprised of a layer-selected multi-layered optical disc of the voltage selection type. When a voltage-layer-selected type multi-layered recording medium is employed, the basic state of each recording layer is assumed to be transparent. Only those layers to which a voltage is applied between the electrode layers, between which the recording layers are disposed, become colored. In the present specification, the direction of the voltage applied when the electrochromic material is colored by H⁺ (proton) or cation is defined as positive. If the coloring function is lost by the recording laser light irradiation and a recording mark is formed, the recording mark would not be visible when all of the layers are brought back to transparency, so that no obstacle would be posed for the recording or reproduction of other layers. Thus, the inter-layer interval can be narrowed due to the absence of interference from other layers, whereby the number of layers and capacity can be increased as compared with conventional multi-layered discs.

The term “electrochromic material layer” herein refers to layers having a region that emits light upon application of a voltage and a region that becomes colored or loses color in response to the emitted light, in addition to those layers of a material that becomes directly colored by voltage application. In order to realize such recording medium, it is only necessary to construct a recording layer with a film stack consisting of an organic or inorganic electrochromic material layer and a solid electrolyte layer, or with a mixed-material layer or a film stack consisting of an electroluminescence material and a photochromic material. In this way, it becomes possible to cause only a selected layer to absorb light while the other layers hardly absorb light. An example of electrochromic material is tungsten oxide or a polymer of thiophene organic molecules. Other examples of electrochromic material include those various materials described in “Electrochromic Display,” Sangyo Tosho Publishing Co., Ltd., first published in Jun. 28, 1991. Many other known electrochromic materials are also available.

The present invention employs a structure in which a plurality of electrochromic films are disposed between a pair of transparent electrodes, instead of the conventional structure in which a single electrochromic recording film layer is sandwiched between a pair of transparent electrodes. Thus, a total of only two pin electrodes are exposed, one at the top and the other at the bottom, on a single pair of transparent electrodes. By applying a specific voltage to the pin electrodes, a desired layer can be colored.

By adopting such structure, the number of transparent electrode layers, which is the biggest problem in achieving the increase in the number of layers, can be reduced. This means that the number of layers that are stacked can be increased so that a greater disc capacity can be achieved. Namely, it becomes easier to design a disc structure such that the number of layers can be increased, and also a cost advantage can be obtained. In particular, ITO, which is used in a variety of devices in a transparent electrode, is a precious material containing indium, of which there is a concern of depletion. The material itself is expensive, so that the decrease in the amount thereof that is used is desirable from the viewpoint of environment and cost as well.

In accordance with the invention, a power supply connected to a voltage transmission mechanism is equipped with a mechanism for varying the value of a DC voltage and/or the mode of application of DC or AC. The power supply may employ, without modification, a currently commercially available pulse generator capable of outputting a desired voltage waveform to the outside.

Recording and reproduction of information are conducted in the following manner. A disc having a plurality of recording layers that become colored upon application of a voltage with a pair of electrodes, between which the recording layers are disposed, is mounted on a disc mount portion fixed to a rotating shaft. The disc mounted on the disc mount portion is fixed in place as it is pushed down by a disc pusher, which rotates together with the disc. A voltage is applied to a pair of electrodes containing a designated recording layer among the multiple recording layers via a pair of contact electrodes provided on the disc contact surface of the disc mount portion, such that the designated one of the recording layers becomes colored. The voltage applied will be described in detail later with reference to embodiments. The designated recording layer thus becomes colored, and recording or reproduction of information is carried out on the colored recording layer by optical irradiation.

In order for the electrochromic film to become colored, an ion or electric charge needs to move from the electrolyte layer to the electrochromic layer, where the energy (voltage) required for the travel across the interface has a threshold. In the following, such ion or electric charge will be referred to as an ion. The threshold varies depending on the type of electrochromic material, the content of ions contained in the electrolyte that contribute to the coloration, and, even among the same material, the property of the film or the condition of interface. Normally, an electrochromic film loses color when the ions that have moved to the electrochromic layer return to the solid electrolyte layer upon termination of voltage application. While the ions move in the direction of elimination of color just by terminating the voltage application, the threshold involved in coloration is also involved in the time it takes for the elimination of color. An electrochromic film with a high threshold state does not lose color for a long time once it becomes colored.

In accordance with the present invention, the following three features of the electrochromic film are taken advantage of:
(1) There is a threshold for the electrochromic film to become colored by voltage.
(2) The value of the threshold is related to the time it takes for the electrochromic film to lose color.
(3) The electrochromic film can be considered to be an electric circuit consisting of resistor and capacitor components.

Based on these three features, the voltage applied to the electrochromic device is controlled, whereby a desired recording layer can be selected in a medium structure having a smaller number of transparent electrode layers than is conventional, and with an apparatus configuration having a smaller number of pin electrodes.

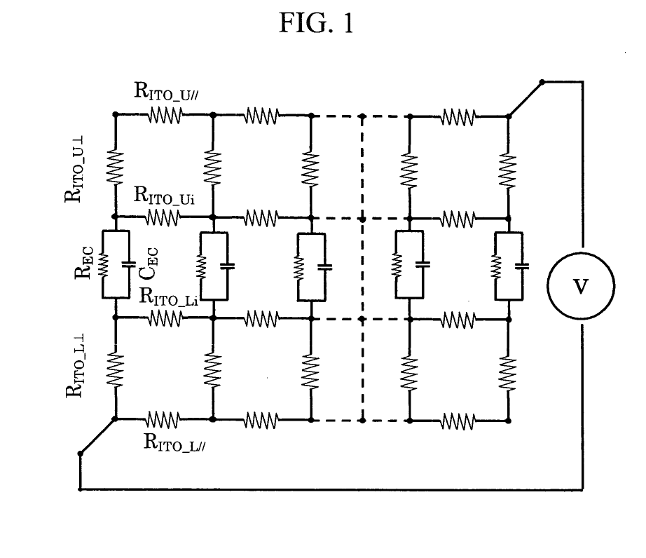

For a discussion of the coloration mechanism in the electrochromic film, an electric equivalent circuit model shown in FIG. 1 is considered. For simplification of the model, each electrochromic film and electrolyte layer does not have any electric equivalent circuit model, but a set of an electrochromic film and an electrolyte layer is considered to be one electrochromic recording film. When the vertical and horizontal directions of the recording films are considered, the following equivalent circuit model can be considered.

Resistance R of each element is indicated with a subscript. The horizontal and vertical resistor components (//·⊥)of the individual transparent electrodes (R_{ITO}_{_{—}}_{L}·R_{ITO}_{_{—}}_{U}) are (R_{ITO}_{_{—}}_{L//}·R_{ITO}_{_{—}}_{U//}) and (R_{ITO}_{_{—}}_{L⊥}·R_{ITO}_{_{—}}_{U⊥}). The resistor components at the interface between each transparent electrode and the electrochromic film are (R_{ITO}_{_{—}}_{Li}·R_{ITO}_{_{—}}_{Ui}). The resistor component of the electrochromic recording film is R_{EC}. The electric capacitance component of the electrochromic recording layer is indicated as C_{EC}. As shown in FIG. 1, a plurality of elements each consisting of a parallel connection of the resistor component and the capacitance component of the electrochromic recording layer are continuously disposed in the plane of the recording film.

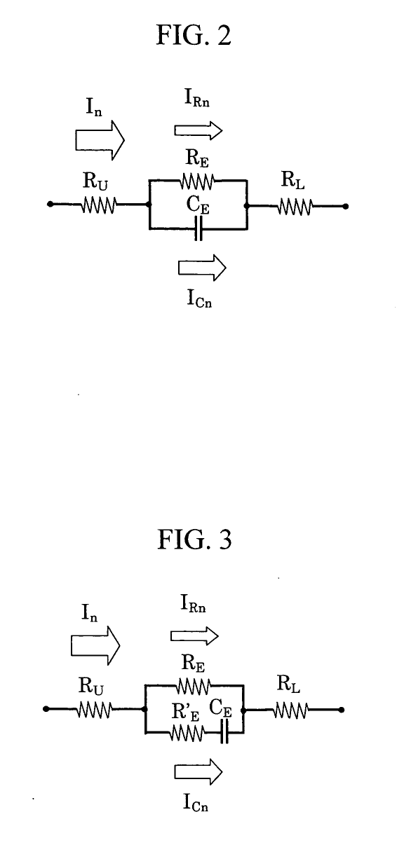

When attention is focused on a path through which a voltage has flowed, the above equivalent circuit model can be simplified as shown in FIG. 2. Attention is focused on a path through which an n-th voltage has flown, and the current that flows through each element is defined by equations (6) and (7):

$$\begin{matrix}{I}_{n} = {I}_{Rn} + {I}_{Cn} & ( 6 ) \\ I = {\sum }_{k = 1}^{1} {I}_{k} & ( 7 )\end{matrix}$$

where Iₙ is a current that flows through the n-th electrochromic circuit, I_{Rn} is the current that flows through the resistor component of the n-th electrochromic circuit, and I_{Cn} is the current that flows through the capacitor component of the n-th electrochromic circuit. I indicates the current that flows through the entire circuit, the value of which is a sum of the currents that flow through all of the elements, as indicated by equation (7).

Depending on the configuration of the medium in the electrochromic device, an equivalent circuit model shown in FIG. 3 may be appropriate. FIG. 3 shows a variation of an element consisting of a parallel connection of the resistor component and the capacitance component of the electrochromic recording layer of FIG. 1, to which another resistor component is added prior to the capacitance component.

In accordance with the invention, attention is focused on the electric characteristics of the electrochromic device, and the configuration of the equivalent circuit is not limited to the one example shown in FIG. 2. The simulation and the media produced in connection with the following embodiments are based on the equivalent circuit model of FIG. 2.

### EXAMPLE 1

### Simulation of Layer Selection by DC Voltage Control

In Example 1, an electric simulation of DC voltage application was conducted as an example of the selection of a layer by controlling the duration of application of a DC voltage according to the invention.

An application method utilizing the transient phenomenon of a DC voltage is shown. In an RC series circuit, when the voltages across the R_{ITO} component and the C_{EC} component are V_{R} and V_{C}, the voltage Vᵢ of the overall circuit can be expressed by the following:

$${V}_{i} = {V}_{R} + {V}_{C} = Ri + \frac{1}{C} \int i d t \qquad ( 8 )$$

The differential equation of Equation (8) is solved using recurrence equations:

$$\begin{matrix}i = \frac{1}{R} ( V - \frac{1}{C} \int i d t ) = \frac{1}{R} ( V - \frac{1}{C} \sum i ) & ( 8 \text{-} 1 ) \\ {i}_{n + 1} = \frac{1}{R} ( V - \frac{1}{C} ( {i}_{n} + {i}_{n - 1} ) ) & ( 8 \text{-} 2 )\end{matrix}$$

where iₙ₋₁, iₙ, and iₙ₊₁ each indicate the current at time n−1, n, and n+1. The integral was substituted by a sum Σ in Equation (8-1), which was then expanded into the recurrence equation according to Equation (8-2). The voltage V_{C} across the capacitor component of the electrochromic recording film can be expressed by Equation (9):

$${V}_{C} = \frac{1}{C} \sum i \qquad ( 9 )$$

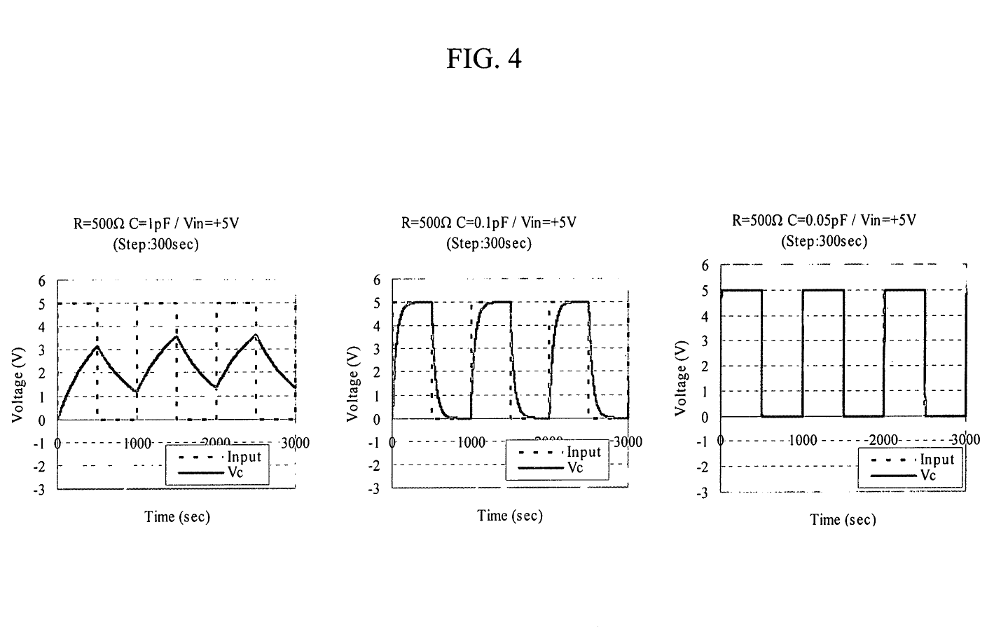

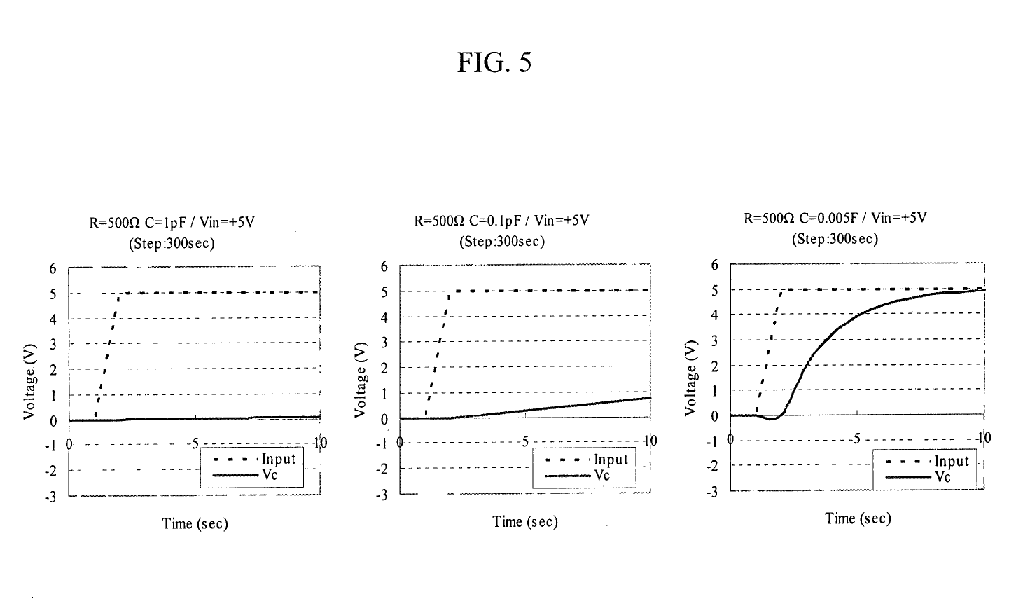

FIG. 4 shows the result of calculating the transient phenomenon of Vc when various values of resistance R and capacitance C were used. The graph at the left corresponds to a film with R=500Ω and C=1 pF. The graph at the center corresponds to a film with R=500Ω and C=0.1 pF. The graph at the right corresponds to a film with R=500Ω and C=0.005 pF. It can be seen that, by varying the resistor component R_{ITO} of the transparent electrode and the capacitance component C_{EC} of the electrochromic recording film, the voltage V_{C} of the electrochromic recording layer varies upon application of a DC voltage with the same step shape. FIG. 5 shows the changes immediately after the application of voltage.

Thereafter, the fact is utilized that the electrochromic film has a threshold. The threshold of voltage necessary for the coloration and the loss of color of the electrochromic film varies depending on the type of the electrochromic material, the content of ion contained in the electrolyte that contributes to coloration, and, even with the same material, on the property of the film, the condition of interface, and so on. Thus, the threshold is apparatus-dependent, and it is difficult to control how the threshold is determined.

The threshold can be changed by newly providing a single SiO₂ intermediate layer as an ion conduction control film between the electrochromic film and the solid electrolyte film and controlling its film thickness, or by controlling the film thickness of the solid electrolyte layer or its water content that contributes to coloration.

In summary, in accordance with the invention, a disc is prepared in which the resistor component R_{ITO} of the transparent electrode and the capacitance component C_{EC} of the electrochromic recording film are controlled, whereby the degree of coloration can be controlled by the DC voltage application time.

It is assumed herein that the voltage (threshold) necessary for coloration is 3V. When the aforementioned three kinds of electrochromic films are connected in parallel, the same voltage is applied to these electrochromic films. When 3 volts DC is applied to each electrochromic film for only 5 seconds, only the film with C=0.005 pF becomes colored. When the voltage is applied for 180 seconds (3 minutes), not only the film with C=0.005 pF but also the film with C=0.1 pF become colored. When the voltage is applied for 300 seconds (5 minutes), all three films become colored. Thus, by controlling the applied voltage and time, the electrochromic film that is colored can be selected.

In the present embodiment, the three recording films are disposed such that the threshold for causing the electrochromic recording layers to be colored simply increases or decreases in the direction in which the recording films are stacked. Namely, the electrochromic recording layer that requires the longest time for coloration (one with C=1 pF in the above example) is disposed closer to the side on which the beam used for recording and reproduction is incident, and the electrochromic recording layers with increasingly shorter coloration times are disposed sequentially away from the beam incident side. Alternatively, the electrochromic recording layer with the shortest coloration time may be disposed closer to the beam incident side, with the electrochromic recording layers with increasingly longer coloration times being disposed sequentially away from the beam incident side.

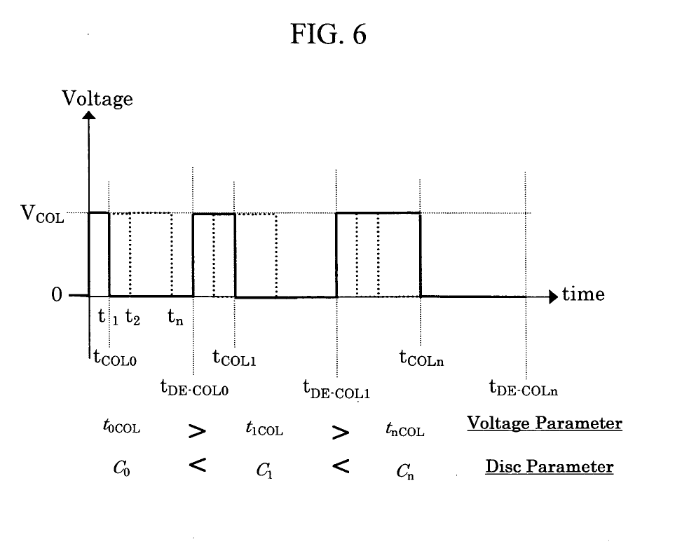

FIG. 6 shows a stepped DC voltage for layer selection. An example is described in which the electrochromic recording layer that requires the highest applied voltage threshold is disposed closer to the beam incident side, with the electrochromic recording layers with increasingly lower applied voltage thresholds being disposed sequentially away from the beam incident side. In this example, a positive voltage V_{COL} is applied up to time tₙ required for a desired layer n to be colored, whereby all of the layers between the layer farthest from the beam incident side and the selected layer are colored. In reality, because recording or reproduction is conducted after coloration, the time is preferably longer than tₙ and yet shorter than tₙ₊₁ when the next layer is colored. Such time is t_{COL}. When the application of the voltage is terminated, the electrochromic film loses color over time t_{DE-COLn}. Because the elimination of color also begins from the layer farthest form the beam incident side, only a desired layer is left colored after a predetermined time elapses.

If the threshold of the applied voltage necessary for coloration and the order in which the layers are stacked are reversed, the coloration by voltage application and the elimination of color upon termination of voltage application would begin with the recording film closest to the beam incident side. However, the procedure for causing a desired layer to be exclusively colored is the same.

FIG. 6 shows the temporal change in the applied voltage for causing the first layer (layer farthest from the beam incident side) to become colored in the first cycle, the first and the second layers to become colored in the second cycle, and all of the first to n-th layers to be colored in the third cycle. In the present case, the time necessary for the elimination of color increases as the number of the layers to be colored increases, as does the time required for coloration. Thus, by controlling the DC voltage, the electrochromic film that is colored can be selected. As shown in FIG. 6, by controlling both the time of application and the level of the DC voltage, the electrochromic film that is colored can be selected.

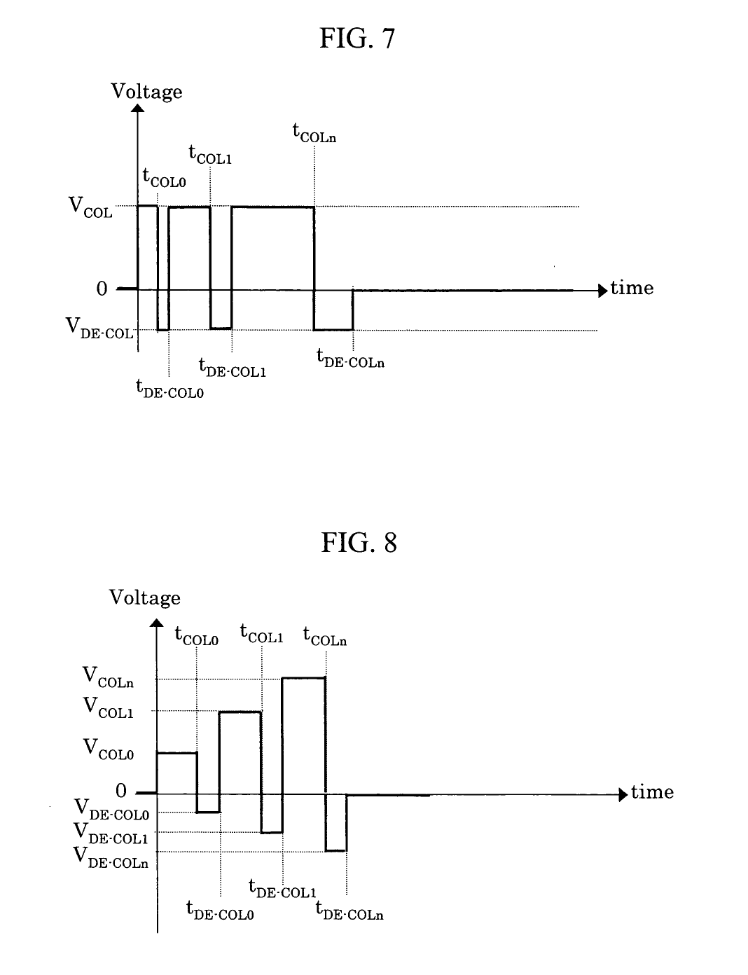

When causing the color to be lost, an inverse voltage V_{DE-COL} may be applied as shown in FIG. 7. By so doing, the rate at which the color is lost can be accelerated.

The voltage value for coloration or the elimination of color may be controlled. For example, as shown in FIG. 8, by increasing the value of the applied voltage as the number of layers to be selected increases, the time required for coloration/elimination of color can be made constant regardless of the number of layers. By using such voltage application method, a distant layer can be accessed for information reading purposes with the same time as required for accessing an adjacent layer.

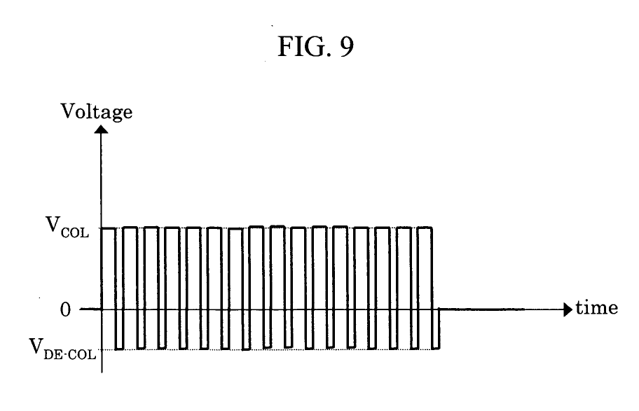

When a specific layer is selected and information is read or written, the voltage is applied in a stepped manner with the amount V_{DE-COL} of the inverse voltage or the application time t_{DE-COL} thereof reduced as compared with the time when eliminating color, as shown in FIG. 9. Namely, it is necessary to discharge the charges stored in the electrochromic recording layer capacitor in the equivalent circuit model instantaneously. By repeating this step, it becomes possible to maintain the state in which the layers are constantly colored. Such repetition of the application of positive and negative voltages in an intermittent manner allows the energy, namely, the amount of heat, stored in the film, to be reduced as compared with the application of a constant voltage for a long time, thereby contributing to the extension of life of the electrochromic recording layers.

### EXAMPLE 2

### Layer Selection by AC Voltage Control

In Example 2, layer selection is carried out by controlling the frequency of an AC voltage. An electric simulation of AC voltage application was conducted. A case is considered in which an AC input voltage is applied to the foregoing RC series circuit. In this case, the circuit equation is expressed by Equation (10):

$$Ri + \frac{1}{C} \int i d t = V sin ( ω t ) \qquad ( 10 )$$

where V is the amplitude of the AC voltage applied, ω is the number of oscillations of the AC voltage, and t is time. Since “current”=“temporal change (differentiation) of charge q stored in a capacitor, Equation (10) is modified to Equation (11):

$$R \frac{d q}{d t} + \frac{1}{C} q = V sin ( ω t ) \qquad ( 11 )$$

Solving the above differential equation with respect to charge q yields Equation (12):

$$\begin{matrix}q = {e}^{- \int \frac{1}{CR} d t} \{ \int \frac{V}{R} sin ( ω t ) {e}^{\int \frac{1}{CR} d t} d t \} \\ = V \frac{1}{ω ( {R}^{2} + \frac{1}{{ω}^{2} {C}^{2}} )} ( \frac{1}{ω C} sin ( ω t ) - R cos ( ω t ) )\end{matrix} \qquad ( 12 )$$

When Z=\sqrt{R²+1/(ω²C²)} and θ=tan⁻¹(1/ωCR), the charge q stored in the capacitor can be expressed by Equation (13):

$$q = - \frac{V}{ω Z} cos ( ω t + θ ) \qquad ( 13 )$$

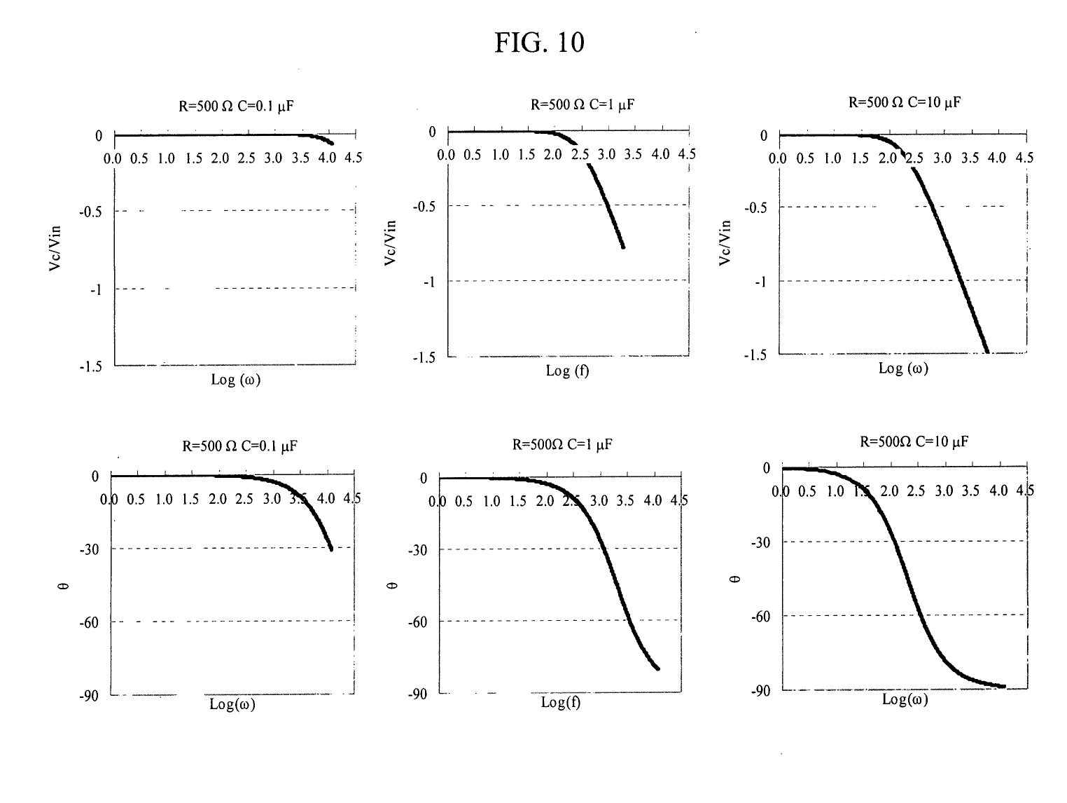

FIG. 10 shows the results of calculating the angular velocity ω, the ratio Vc/Vin of input AC amplitude Vin to output AC amplitude Vc, and phase difference θ when various resistance R and capacitance C are used. The graph on the left in FIG. 10 shows the results for a film with R=500Ω and C=0.1 μF. The graph at the center corresponds to the results for a film with R=500Ω and C=1 μF. The graph at the right corresponds to the results for a film with R=500Ω and C=10 μF. As will be seen from these graphs, the series RC circuit functions as a low-pass filter. It can be seen that, by thus changing the resistance component R_{ITO} of the transparent electrode and the capacitance component C_{EC} of the electrochromic recording film, the voltage V_{C} of the electrochromic recording film upon application of the AC voltage is changed. As a parameter that determines the output voltage, attention is focused on the cut-off frequency.

In the present example, the three recording films are disposed such that the cut-off frequency of the electrochromic recording films simply increases or decreases in the direction in which the films are stacked. Namely, the recording film with the smallest cut-off frequency is disposed closest to the side on which the beam used for recoding or reproduction is incident, and the electrochromic recording film with the largest cut-off frequency is disposed farthest from the beam incident side. Alternatively, the recording film with the highest cut-off frequency is disposed closest to the beam incident side, while the electrochromic recording films with smaller cut-off frequencies are disposed farther from the beam incident side.

It is assumed herein that the voltage (threshold) necessary for coloration is 3V and that the applied voltage is 10V. A condition for coloration is that, when an AC voltage with a certain angular velocity is applied, an output ratio of 0.3 (or Log(0.3) which is approximately 0.5 since the drawing is represented in logarithmic axis) is obtained. For example, in the case of the above three kinds of electrochromic films, when an AC voltage with an angular velocity 10⁴ rd/sec (Log(10000)=4) is applied to each electrochromic film, the film on the left of FIG. 10 with C=0.1 μF (which is located farthest from the beam incident side) alone is colored. When an AC voltage with an angular velocity of 3×10³ rd/sec (Log(3000)=3.5) is applied, not only the film with C=0.1 μF but also the film with C=1 μF shown at the center of FIG. 10 are colored. When an AC voltage with an angular velocity of 10³ Hz rd/sec (Log(1000)=3) is applied, all three films including the film with C=10 μF shown on the right of FIG. 10 are colored. The relationship between angular velocity ω and frequency f is given by ω=2πf, so that the recording film that is colored can be selected by changing the frequency of the AC voltage that is applied.

The AC voltage for layer selection is as follows. When a single period of the waveform is considered, the concept is substantially identical to that of the stepped application of a DC voltage. A positive voltage V_{COL} is applied up to a time required for a desired layer n to be colored, whereby all of the layers between the layer closet to or farthest from the beam incident side and the selected layer are colored. Thereafter, the electrochromic film loses color after a negative voltage V_{DE-COL} with always the same amount of voltage is applied thereto for the same time. Because it is AC, the applied voltage changes constantly, and only a portion of the voltage contributes to the coloration or elimination of color of the electrochromic recording film.

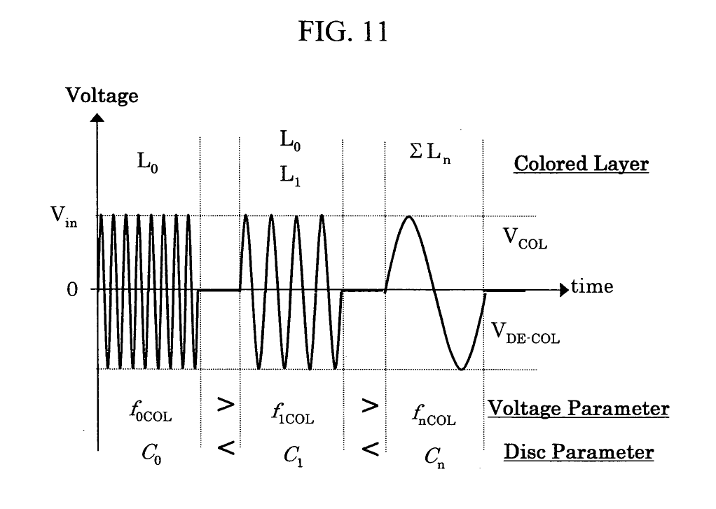

FIG. 11 shows the waveforms of applied voltages, with the first block showing the waveform for coloring the first layer located farthest from the beam incident side, the second block for coloring the first and the second layers, and the third block for all of the first to the n-th layers.

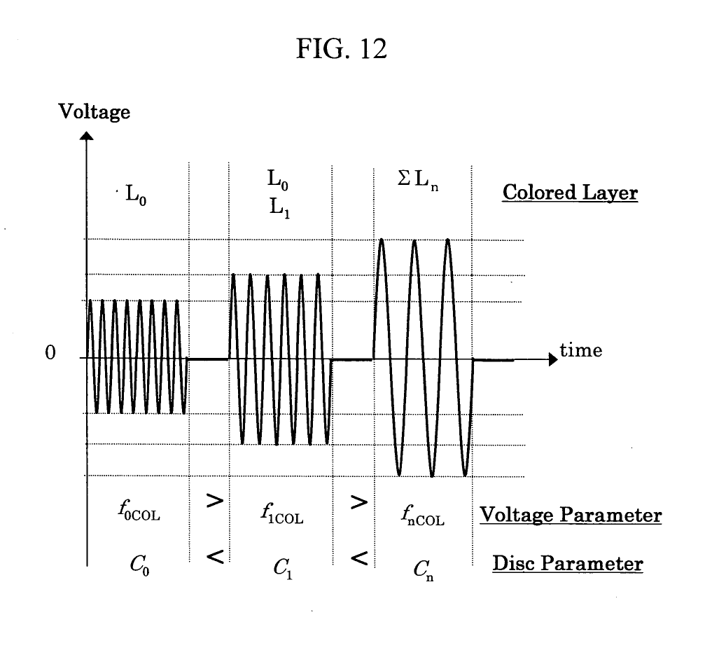

The value of voltage used for the coloration or elimination of color may be controlled, as in the case of DC voltage application. For example, as shown in FIG. 12, for using the voltage being applied gains for selecting the number of layers, the range of the output frequency of the apparatus can be changed. By using such voltage application method, it becomes possible to select a layer using a power supply having a narrower frequency range.

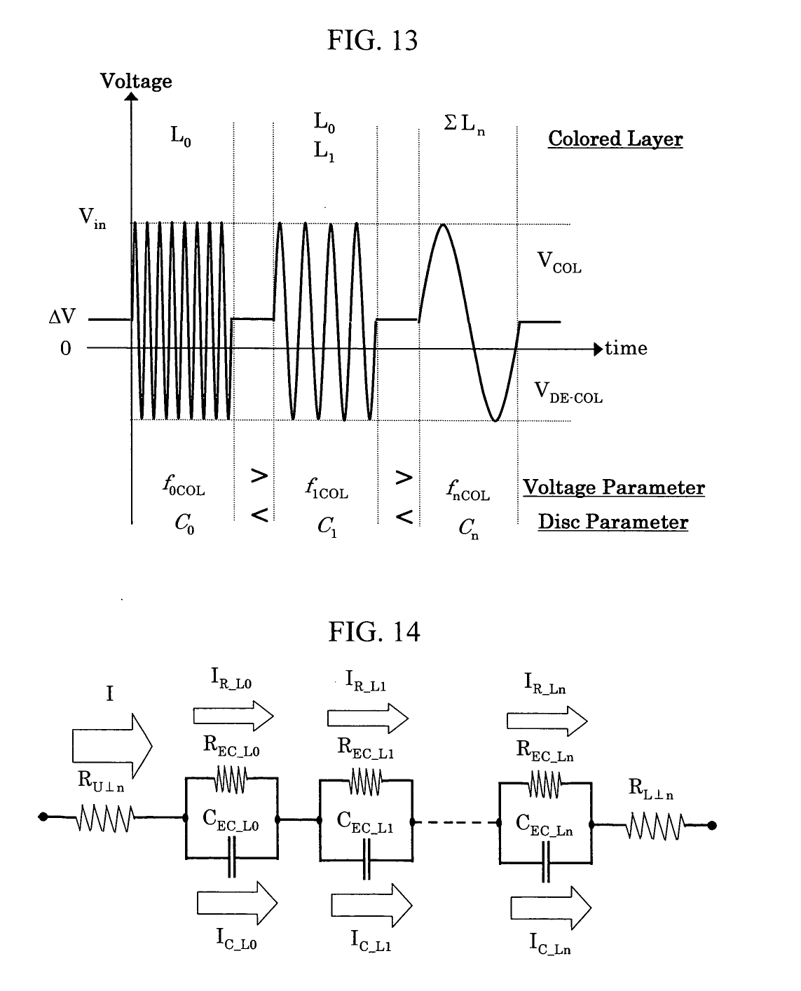

The applied AC voltage may be given an offset. For example, as shown in FIG. 13, by giving a positive offset to the applied voltage, the temporal ratio of the positive voltage to the negative voltage and the amounts thereof that are applied to the electrochromic recording layer can be controlled. In the electrochromic recording film, the negative voltage may be smaller than the positive voltage required for coloration. By using such voltage application method, an improvement in durability can be expected without applying an excessive voltage to the electrochromic film.

### EXAMPLE 3

### Method for Selecting a Desired Layer when a Plurality of Layers are Stacked Sequentially

FIG. 14 shows an electric equivalent circuit of an electrochromic device consisting of a sequential stack of a plurality of layers.

While in FIG. 14, a plurality of electrochromic films are arranged in series, the device structure may consist of these films arranged in parallel. In either case, since an electric equivalent circuit is given, the value of the voltage applied to each electrochromic film can be determined by solving a circuit equation.

In the foregoing description, when an electrochromic film is selected, all of the electrochromic films that exist between the farthest electrochromic film and the selected electrochromic film became colored or lost color. Thus, in the next step, a voltage application is conducted so as to select a desired single layer.
(1) Layers that are easier to be colored are disposed farther away from the beam incident side (i.e., the layers with higher thresholds of the voltage necessary for coloration or elimination of color are disposed closer to the beam incident side). Alternatively, the layers that are easier to be colored may be disposed closer to the beam incident side.
(2) All of the layers between the most easily colored layer and a selected layer are colored.
(3) An inverse voltage is applied so as to eliminate the color of the layers before the selected layer.

In this configuration, the recording film including a plurality of electrochromic layers needs to satisfy the conditions (1) and (3). However, because it can be assumed that the more difficult it is for a layer to be colored, the more difficult it will be for the layer to lose color, a recording film that satisfies these conditions can be produced by the following methods. In order to control these three conditions, the following methods (1) to (3) are available, as mentioned in connection with the description of thresholds.
(1) A method whereby the threshold or the electric equivalent circuit is controlled by varying the conditions for the formation of a plurality of recording films, or the film thickness thereof.
(2) A method whereby an ion conduction control film is provided between the electrochromic film and the solid electrolyte film that supplies an ion, and the threshold or the electric equivalent circuit is controlled by changing the conditions for the formation of the ion conduction control film or the thickness thereof.
(3) The threshold or the electric equivalent circuit is controlled by means of a plurality of kinds of electrochromic films, solid electrolyte films, or ion conduction control films.

### EXAMPLE 4

### Layer Selection by DC Voltage Control

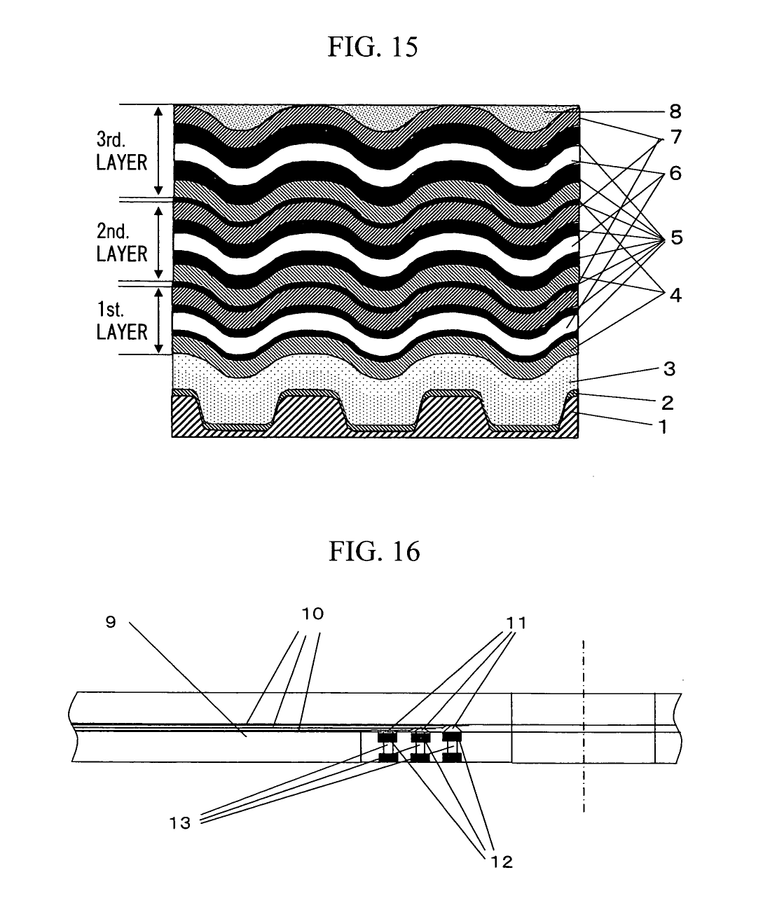

As shown in FIG. 15, a polycarbonate substrate 1 measuring 12 cm in diameter and 0.6 mm in thickness and having on the surface thereof a tracking groove for in-groove recording with a track pitch of 0.74 μm, a depth of 60 nm, and a groove width of 0.35 μm had address information recorded in the form of wobbles of the groove. On this substrate 1, an Ag₉₄Pd₄Cu₂ semitransparent reflecting layer 2, and an ITO transparent electrode 3 were formed. A recording film was comprised of a reductive electrochromic material layer 4, an ion conduction control layer 5, a solid electrolyte layer 6, another ion conduction control layer 5, and an oxidative electrochromic layer 7. Such stacking was repeated twice, thereby producing a multi-layered recording medium including three layers of recording layers, which was sandwiched with an ITO transparent electrode 8. Finally, an UV curing resin layer was coated.

The electrochromic material layer included a layer of tungsten oxide WO₃ and iridium oxide IrOx (x is a positive number smaller than 1) as a coloring material. On top of this, a layer of solid electrolyte material was stacked via an ion conduction control layer. The electrochromic material layer, which was formed by sputtering, was colored by applying a voltage between the upper and lower electrodes. Each layer was formed by sputtering or coating, and light was incident thereon from above. The wavelength of laser was 660 nm, and the track pitch was 0.74 μm.

Each of the recording layers had a three-layer structure in which another layer was added on top of the solid electrolyte layer. The three-layer structure consists of, for example, a layer of IrOx or NiOx (x is a positive number smaller than 1) as an oxidatively colored first colored layer, a layer of Ta₂O₅ as a solid electrolyte layer, and a layer of WO₃ as a reductively colored second colored layer. In this structure, the solid electrolyte film is sandwiched between both the oxidative and reductive electrochromic films, whereby the ion in the solid electrolyte that contributes to coloration can be efficiently utilized and the voltage required for coloration can be reduced.

With regard to the layer structure, the acrylic UV curing resin was formed of Li triflate (formal designated as Li trifluoromethanesulfonate), and the solid electrolyte layer was formed of tantalum pentoxide Ta₂O₅. The electrochromic material layer consists of three layers, such as, for example, a layer of 100 nm of IrOx or NiOx (x is a positive number smaller than 1) as an oxidatively colored first colored layer, a layer of 300 nm of Ta₂O₅ as a solid electrolyte layer, and a layer of 150 nm of WO₃ or MoOx as a reductively colored second colored layer. The electrochromic material layer may consist of a double-layer structure. In the case of the double-layer structure, the layer consists of, for example, a solid electrolyte layer of 300 nm of tantalum pentoxide Ta₂O₅, and a colored material layer of 150 nm of WO₃.

These multiple types of electrochromic materials may be used in each of the recording layers. Because the energy required for expressing the electrochromic phenomenon, namely, the threshold according to the invention, varies depending on the material, a layer can be selected by changing the type, thickness, or density of electrochromic material.

One advantage of using an inorganic material layer is that, because its optical characteristics (index of refraction) are close to those of the transparent electrode ITO, its thickness can be accurately controlled by sputtering. As a result, it is possible to produce a multi-layered information recording medium with high reproducibility, high transparency, and designed electric characteristics. Further, because all of the layers of which the multi-layered information recording medium is comprised can be made by sputtering, the existing optical disc production line can be utilized.

Examples of the material that can be used in the electrochromic material layer include organic materials such as polythiophene organic polymers, and thiophene organic oligomer or polymers. Electrically conductive organic material can be formed by coating and has an excellent coloration efficiency. A polymer of thiophene is formed by vacuum deposition or electrolytic polymerization. In the case of electrolytic polymerization, poly(3-methylthiophene), which is a thiophene derivative, is used as a monomer, LiBF₄ is used as a supporting electrolyte, and benzonitrile is used as a solvent.

An advantage of using an organic material layer is that because it is electrically conductive, its conductivity increases as the temperature rises and its photoconductivity/recording sensitivity can be enhanced by accelerating the photocarrier with an electric field and causing a temperature rise. Another advantage is that it does not require the entry or exit of water (proton) to or from the film for coloration or the elimination of color, as in the case of WO₃. Coloration occurs as electrons are given to the molecules by the transfer of ions such as Li to the vicinity of the molecules, resulting in an optically excitable state. Because the conductivity is greater than that of an inorganic solid electrolyte, it is also possible to control the threshold of voltage necessary for coloration using an organic and an inorganic solid electrolyte.

The control of the threshold of voltage necessary for coloration of each recording layer and the electric characteristics values were carried out by changing the film thickness of SiO₂, namely the ion conduction control layer 5. The thickness was increased from 0 nm (no film), 3 nm, and 10 nm from the layers closer to the substrate. The threshold of voltage necessary for coloration and the electric characteristics values were determined by producing a sample in advance of a single layer having the ion conduction control layer of each SiO₂, and then measuring such samples. The threshold was determined by measuring the voltage value at which a change in transmittance was observed as the sample became colored while the DC voltage was gradually increased. The electric characteristics values were determined by calculating an equivalent circuit by measuring impedance.

As the film thickness of SiO₂ was increased from 0 nm to 3 nm to 10 nm, the threshold necessary for coloration increased from 0.1V to 0.3V to 0.9V, and the values of the resistor and capacitor components also increased from (0.5 kg, 15 μF) to (4.0 kΩ, 20 μF) to (8.0 kΩ, 40 μF). These characteristics values satisfy the conditions for a medium necessary for the selection of a desired one of the aforementioned multiple recording layers.

As a voltage corresponding to the recording layer desired to be recorded or reproduced is applied to the transparent electrode, that layer alone is colored so that it absorbs or reflects laser light. Thus, information can be recorded or read from the colored layer alone selectively by irradiating it with laser light with a wavelength of 660 nm. Since the other recording layers are not colored, they do not show any changes.

Further, a polycarbonate substrate 9 with a diameter of 120 mm and a thickness of 0.6 mm was affixed on top, as shown in FIG. 16. The light was shone from this side on which the substrate was affixed. Instead of the transparent electrode located farthest from the light incident side, a metal electrode such as W—Ti may be used. The reflecting layer/electrode and the transparent electrode 10 were each provided with an extraction electrode 11 at the periphery thereof. These electrodes were connected to a plurality of electrodes 12 near the central hole of the disc for connection with separate electrodes on the disc rotation shaft. When the disc is mounted on the rotating shaft, the disc as shown is turned upside down. A plurality of electrodes 13, each having a slight spring-like property, are provided on the disc-receiving portion of the rotating shaft, at positions corresponding to the electrodes on the disc, and are in contact with the individual electrodes of the disc.

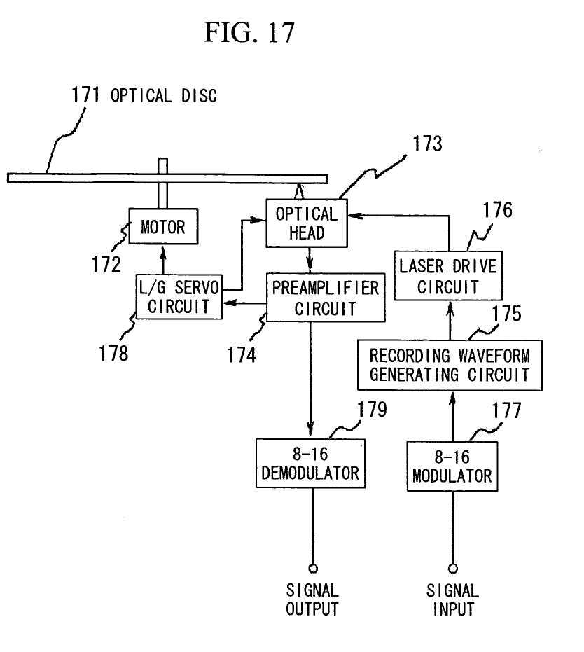

Information was recorded and reproduced using the above recording medium. The operation for the recording and reproduction of information is described with reference to FIG. 17. Initially, the ZCAV (Zoned Constant Linear Velocity) system is described, which is a motor control method employed during recording and reproduction whereby the number of rotations of the disc is varied from one zone to another where recording or reproduction is carried out.

Each piece of data is transmitted to a 8-16 modulator 177 in units of 8 bits. Information was recorded on the information recording medium 171 by the 8-16 modulation system whereby 8 bits of information are converted into 16 bits. In this modulation system, information with mark lengths of 3 T to 14 T associated with the 8-bit information is recorded on the medium. The modulation is carried out by the 8-16 modulator 177 shown in the drawing, where T indicates the clock period during the recoding of information. The disc was rotated at a linear velocity of 15 m/s relative to the optical spot.

Digital signals of 3 T to 14 T converted by the 8-16 modulator 177 are transferred to a recording waveform generating circuit 175 by which a multipath recording waveform is generated. In the recording waveform generating circuit 175, the signals of 3 T to 14 T are associated with 0s and 1s alternately along the time axis. The recording waveform generating circuit 175 also includes a multipath waveform table adapted to a system for varying the pulse widths at the head and at the end of a multipath waveform depending on the length of spaces before and after a mark portion, when forming a series of high-power pulse sequence for the formation of the mark portion (adaptive recording waveform control). In this way, a multipath recording waveform can be generated while the influence of inter-mark thermal interference caused between marks is reduced as much as possible.

The waveform generated by the recording waveform generating circuit 175 is transferred to a laser drive circuit 176, which, based on the recording waveform, causes the semiconductor laser in the optical head 173 to emit light. The optical head 173 employs a semiconductor laser with an optical wavelength of 660 nm as a laser beam for information recording. The laser light is focused on the recording layer of the optical disc 171 by an objective lens with NA0.65, thus irradiating the disc with the laser beam and recording the information thereon.

Based on such recording principle, the same or separate recording tracks are shone with multiple optical spots emitted by a single or a plurality of optical heads, whereby the speed of recording can be increased.

In the present example, in order to determine whether or not a layer selection can be conducted, recording films with different sizes were stacked to make independent regions of recording films, and the coloration and the loss of color in each recording layer were visually observed.

When 2V DC was applied between a pair of transparent electrodes with recording films for 1 minute, none of the recording layers was colored. When 3V DC was applied, the recording film in the first layer alone, which was closest to the substrate 1 and which did not include the ion conduction control layer SiO₂, was visually observed to have been colored one minute later. As the application of voltage was continued for 10 minutes, the recording film in the second layer in the middle including an ion conduction control layer SiO₂ with a film thickness of 3 nm gradually became colored. However, even after the application of the voltage for one hour, no coloration was observed in the recording film in the third layer that included an ion conduction control layer SiO₂ with a film thickness of 10 nm and that was closest to the light incident side.

When 7V DC was applied, the recording film in the first layer alone, which was closest to the light incident side and which did not include an ion conduction control layer SiO₂, was visually observed to have been colored two seconds later. As the application of the voltage was continued for one minute, the recording film in the second layer disposed in the middle, which included an ion conduction control layer SiO₂ with a film thickness of 3 nm, was visually observed to have been gradually colored. As the application of the voltage was continued for 10 minutes, the recording film in the third layer closest to the light incident side including an ion conduction control layer SiO₂ with a film thickness of 10 nm was also colored.

Thereafter, the elimination of color by an inverse voltage was analyzed. After applying 7V DC for 10 minutes, an inverse voltage of −1V was applied for one minute, with all of the recording films being colored. As a result, the recording film in the farthest, first layer alone showed the loss of color. 7V DC was once again applied so as to bring all of the recording films back to the state where they all became colored, and then an inverse voltage of −2V was applied for 2 minutes. As a result, the recording layers in the first layer in the back and in the second layer in the middle lost color, while the recording layer in the third layer in front, though it became lighter in shade somewhat, still remained colored.

When 3V was applied for 10 minutes, the recording film in the first layer in the back and the recording film in the second layer in the middle became colored. When an inverse voltage of −1V was applied for one minute, the recording film in the first layer in the back alone lost its color, while the recording film in the second, middle layer remained colored, though it became lighter in shade somewhat.

The above results are summarized as follows.
(1) Method for exclusively selecting the first layer on the substrate side: Apply 3V DC for one minute.
(2) Method for exclusively selecting the middle, second layer: Apply 3V DC for 10 minutes, and then apply an inverse voltage of −1V for one minute.
(3) Method for exclusively selecting the third layer in front: Apply 7V DC for 10 minute, and then apply an inverse voltage of −2V for two minutes.

These results indicate that desired layers were selected by controlling the amount and time of application of DC voltage to the medium having a plurality of layers with different thresholds of application voltage necessary for coloration.

It is noted that because the threshold and the electric equivalent circuit were determined based on single-layer films, they do not accurately represent the actual threshold and electric equivalent circuit of each recording film in the sample stack. Thus, the layer selection conditions were determined by actually applying a voltage and examining the state of coloration.

### EXAMPLE 5

### Layer Selection Based on AC Voltage Control

In the following, an example is described in which the applied voltage was AC rather than DC for layer selection.

The medium consisted of a single layer of electrochromic film instead of the three-layer structure according to Example 4. In this case, preferably a layer of WO₃, which is reductive is used, from the viewpoint of voltage value necessary for coloration and coloration efficiency. Although the voltage value necessary for coloration increases as compared with the three-layer structure, the medium structure can be simplified and it becomes easier to determine its electric characteristics.

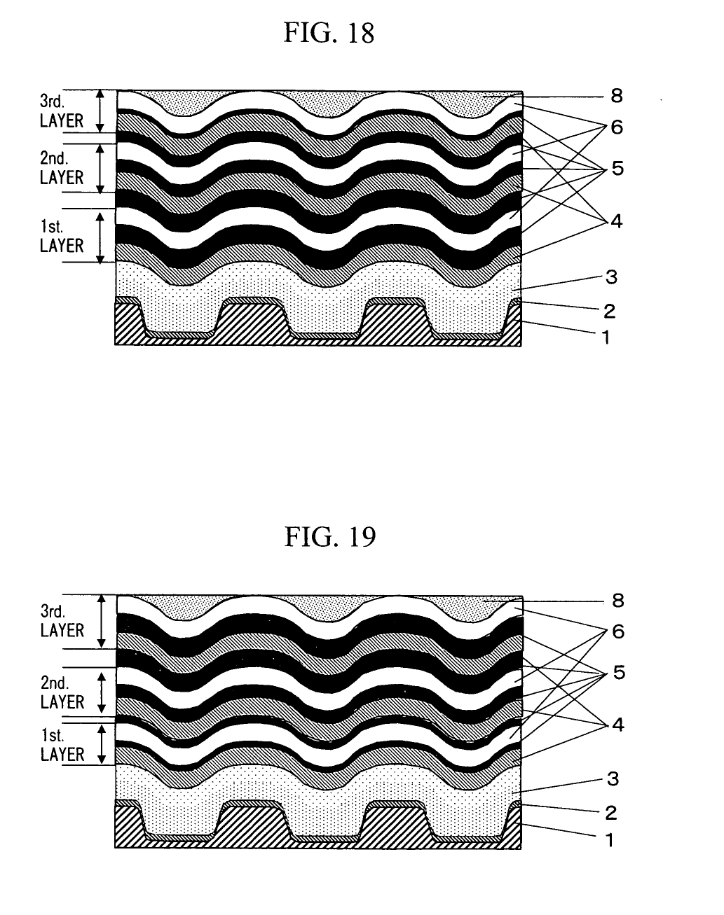

As shown in FIG. 18, a polycarbonate substrate 1, which measures 12 cm in diameter and 0.6 mm in thickness, had a tracking groove for in-groove recording with a track pitch of 0.74 μm, a depth of 60 nm, and a groove width of 0.35 μm. Address information was provided in the form of wobbles of the groove. A semitransparent reflecting layer 2 of Ag₉₄Pd₄Cu₂, and an ITO transparent electrode 3 were formed on the substrate. Recording films consist of a reductive electrochromic material layer 4, an ion conduction control layer 5, a solid electrolyte layer 6, and another ion conduction control layer 5. Such stacking was repeated twice, thereby preparing a multi-layered recording medium including three recording layers, which were capped with an ITO transparent electrode 8. Finally, a UV curing resin layer was coated.

In the electrochromic material layer, a layer of tungsten oxide WO₃ was used as coloring material. On top of this, the solid electrolyte material was stacked via the ion conduction control layer. The electrochromic material layer is colored by applying a voltage between the upper and the lower electrodes. Each of the layers was formed by sputtering or coating, and light was shone thereon from above. The wavelength of laser was 660 nm and the track pitch was 0.74 μm. With regard to the layer structure, the acrylic UV curing resin was formed of Li triflate (formal designated as Li trifluoromethanesulfonate), and the solid electrolyte layer was formed of tantalum pentoxide Ta₂O₅. The electrochromic material layer consisted of two layers, namely, a solid electrolyte layer of 300 nm of tantalum pentoxide Ta₂O₅, and a colored material layer of 150 nm of WO₃.

The control of the threshold of voltage necessary for coloring each recording layer and the electric characteristics values was conducted by varying the film thickness of SiO₂, which was the ion conduction control layer 5. The film thicknesses of SiO₂ were, in order of increasing distance from the substrate, 10 nm, 3 nm, and 0 nm (no layer).

When an AC voltage with an amplitude of 5V and frequency of 10² Hz was applied, the recording film closest to the laser incident side that did not include the ion conduction control layer SiO₂ alone was visually observed to have been colored one minute later. However, even after the application of the voltage was continued for one hour, no coloration was observed in the recording film in the second layer from the laser incident side and in the recording film in the first layer in the back.

When an AC voltage with an amplitude of 5V and frequency of 10⁵ Hz was applied, the recording film in the third layer closest to the laser incident side that did not include the ion conduction control layer SiO₂ and the recording film in the second layer from the laser incident side that included the ion conduction control layer SiO₂ with a film thickness of 3 nm were observed to have been colored one minute later. However, even after the application of the voltage was continued for one hour, no coloration was observed in the recording film in the first layer farthest from the laser incident side.

When an AC voltage with an amplitude of 5V and frequency of 10⁷ Hz was applied, coloration was observed in all of the recording films one minute later. These recording films were colored substantially simultaneously.

Thereafter, the elimination of color using an inverse voltage was conducted under the conditions analyzed for the DC voltage. With all of the recording films colored, an inverse voltage of −3V was applied for 2 minutes. As a result, the loss of color was observed in the recording layer in the third layer closest to the laser incident side and in the recording layer in the second layer from the laser incident side. The recording layer in the first layer farthest from the laser incident side remained colored, although it became lighter in shade somewhat. When an inverse voltage of −2V was applied for one minute, with the recording layer in the third layer closest to the laser incident side and the recording layer in the second layer from the laser incident side colored, the recording layer in the third layer alone, which was closest to the laser incident side, lost color, while the recording layer in the second layer from the laser incident side remained colored, though it became lighter in shade somewhat.

These results are summarized as follows.
(1) Method for exclusively selecting the recording film closest to the laser incident side: Apply an AC voltage with amplitude 5V and frequency 10² Hz for one minute.
(2) Method for exclusively selecting the recording film in the second layer from the laser incident side: Apply an AC voltage with amplitude 5V and frequency 10⁵ Hz for one minute, and then apply an inverse voltage of −2V for one minute.
(3) Method for exclusively selecting the recording film in the third layer farthest from the laser incident side: Apply an AC voltage of amplitude 5V and frequency 10⁷ Hz for one minute and then apply an inverse voltage of −3V for 2 minutes.

It is noted that in the case of a medium shown in FIG. 19 in which the film thicknesses of SiO₂ or the ion conduction control layers 5 were 0 nm (no layer), 3 nm, and 10 nm from the layers closer to the substrate, the methods for selecting the recording layer in the first layer and the recording layer in the second layer are reversed. Namely:
(1) Method for exclusively selecting the recording film closest to the laser incident side: Apply an AC voltage with amplitude of 5V and frequency of 10⁷ Hz for one minute and then apply an inverse voltage of −3V for 2 minutes.
(2) Method for exclusively selecting the recording film in the second layer from the laser incident side: Apply an AC voltage with amplitude of 5V and frequency of 10⁵ Hz for one minute, and then apply an inverse voltage of −2V for one minute.
(3) Method for exclusively selecting the recording film in the third layer from the laser incident side: Apply an AC voltage with amplitude of 5V and frequency of 10² Hz for one minute.

The greatest advantage of using an AC voltage for layer selection is that, as opposed to the DC voltage, there is no need to vary the voltage value (amplitude) or the application time greatly. This is due to the fact that, as mentioned with reference to an electric equivalent circuit, because the recording film has a capacitor component, its effective impedance value can be changed by varying the frequency, whereby the value of voltage applied to the electrochromic film can be controlled. An offset may be added to the AC voltage. By so doing, the amount of voltage that is applied per unit time can be increased, so that it becomes possible to reduce the time required for coloration or the elimination of color.

These results suggest that a desired layer can be selected by controlling the frequency of an AC voltage or the amplitude of a DC voltage applied to a medium having a plurality of recording films having different thresholds of voltage necessary for coloration.

### EXAMPLE 6

### Layer Selection Exclusively by the Direction of DC Voltage

An example is described in which layer selection was conducted by controlling the direction (positive/negative) of the applied DC voltage alone. The structure of the electrochromic recording layer or the like that is not described herein is the same as that of Example 4.

In a layer-selected optical disc, as layers are sequentially stacked while the conditions concerning the threshold of each recording film and the electric equivalent circuit are satisfied, the conditions become more and more stringent regarding the film thickness of the recording films that are disposed in the back as seen from the light incident side or the applied voltage required for coloration, as the number of layers increases.

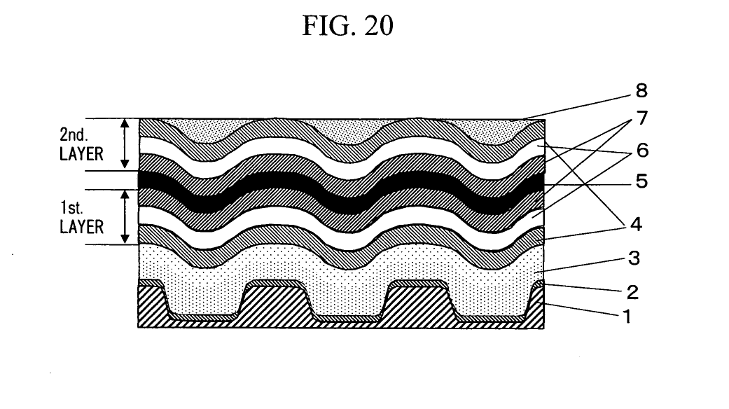

In response, a film structure was designed such that, focusing on the direction of the voltage, layer selection is conducted based on the direction of the voltage alone without greatly changing the magnitude or time of the applied voltage amount. FIG. 20 shows the layer structure of a layer-selected optical disc according to the present example. As in FIG. 15, the disc included a polycarbonate substrate 1 having a diameter of 12 cm and a thickness of 0.6 mm, on the surface of which a tracking groove for in-groove recording was provided which had a track pitch of 0.74 μm, a depth of 60 nm, and a groove width of 0.35 μm. Address information was recorded in the form of wobbles of the groove. On this substrate, an Ag₉₄Pd₄Cu₂ semitransparent reflecting layer 2 and an ITO transparent electrode 3 were formed. The recording films consisted of a reductive electrochromic material layer 4, a solid electrolyte layer 6, and an oxidative electrochromic layer 7. Such stacking was repeated once again, with the order of stacking reversed, whereby a multi-layered recording medium having two layers of recording layers was prepared. The ion conduction control layer 5, although not necessarily required, was provided as a boundary between the first layer and the second layer. Finally, the multi-layered recording layer was capped with an ITO transparent electrode 8.

The individual layers of which a film was composed were not different from those of FIG. 15. However, the order of stacking was different, so that, by changing the direction of the applied voltage, only one of the recording films shown in FIG. 20 can be caused to become colored. Further, in the present example, it is possible to increase the rate at which layer selection is conducted because as one of the films is caused to become colored, an inverse voltage is applied to the other recording film such that its color is eliminated.

With regard to the layer structure, the acrylic UV curing resin was formed of Li triflate (formally designated as Li trifluoromethanesulfonate), and the solid electrolyte layer was formed of tantalum pentoxide Ta₂O₅. The electrochromic material layer consisted of either two or three layers. In the case of three layers, the structure was formed of a layer of 100 nm of IrOx or NiOx (x is a positive number smaller than 1) as an oxidatively colored first colored layer, a layer of 300 nm of Ta₂O₅ as a solid electrolyte layer, and a layer of 150 nm of WO₃ as a reductively colored second colored layer.

Alternatively, the electrochromic material layer may consist of a double-layer structure of a reductive electrochromic material WO₃ and a solid electrolyte Ta₂O₅. In the case of the double-layer structure, the structure may be greatly simplified, with Ta₂O₅ being sandwiched between WO₃. The double-layer structure is formed of a solid electrolyte layer of 300 nm of tantalum pentoxide Ta₂O₅, and a colored material layer of 150 nm of WO₃, for example. In this case, too, it was possible to cause either one of the recording films to become colored or selected by simply changing the direction of the applied DC voltage.

While the layer selection based on the control of the direction of voltage in the present example involves only two layers disposed between a pair of transparent electrodes, still the number of transparent electrodes in the information recording medium including a number of layers of recording films can be halved. Further, the layer selection based on the control of the direction of voltage and the layer selection based on the control of the threshold or the electric equivalent circuit may be implemented in combination.

What is claimed is:

1. A multi-layered optical recording medium comprising a pair of electrodes and a plurality of electrochromic recording layers stacked between the pair of electrodes,
wherein a layer select voltage determined by controlling one or a combination of the value of a DC voltage, application time, the frequency of an AC voltage, and amplitude is applied to the pair of electrodes so as to cause a desired one of the plurality of recording layers to become colored.

2. The multi-layered optical recording medium according to claim 1, wherein a threshold of an applied voltage required for coloration of the electrochromic recording layers simply increases or decreases in a direction from a side closer to a light incident side to a side farther therefrom.

3. The multi-layered optical recording medium according to claim 1, wherein the cut-off frequency of the plurality of electrochromic recording layers simply increases or decreases from a side closer to a light incident side to a side farther therefrom.

4. The multi-layered optical recording medium according to claim 1, wherein the electrochromic recording layers each comprise a stack of an oxidatively colored electrochromic material layer, a solid electrolyte layer, and a reductively colored electrochromic material layer.

5. The multi-layered optical recording medium according to claim 1, wherein the electrochromic recording layers each comprise a stack of an oxidatively colored or reductive electrochromic material layer and a solid electrolyte layer.

6. The multi-layered optical recording medium according to claim 1, wherein the electrochromic recording layers each comprise an oxidatively colored or reductive electrochromic material layer as a first layer, a solid electrolyte layer as a second layer, and an oxidatively colored or reductive electrochromic material layer as a third layer, the third layer having the same coloration mechanism as the first layer.

7. The multi-layered optical recording medium according to claim 1, comprising a plurality of groups of the pair of electrodes and the plurality of electrochromic recording layers.

8. An information recording method comprising:
providing a multi-layered optical recording medium comprising a plurality of electrochromic recording layers disposed between a pair of electrodes, wherein the layers are stacked such that a threshold of a voltage required for coloration simply increases or decreases in a direction from a side closer to a light incident side to a side farther from the light incident side, or such that the cut-off frequency simply increases or decreases in a direction from a side closer to the light incident -side to a side farther from the light incident side;
applying a layer select voltage to the pair of electrodes so as to cause a selected one of the plurality of electrochromic recording layers to become colored; and
irradiating the multi-layered optical recording medium with light so as to record information in the selected recording layer.

9. The information recording method according to claim 8, wherein the layer select voltage is a DC voltage of which the application time is controlled.

10. The information recording method according to claim 8, wherein the layer select voltage is a DC voltage of which the voltage value is controlled.

11. The information recording method according to claim 8, wherein the layer select voltage is an AC voltage of which the amplitude value with an offset placed on top is controlled.

12. The information recording method according to claim 8, wherein the layer select voltage is an AC voltage of which the frequency is controlled.

13. The information recording method according to claim 8, wherein the layer select voltage is determined by a combination of two or more of a DC voltage of which the application time is controlled, a DC voltage of which the voltage value is controlled, an AC voltage of which the amplitude value is controlled, and an AC voltage of which the frequency is controlled.

14. An information reproduction method comprising:
providing a multi-layered optical recording medium comprising a plurality of electrochromic recording layers disposed between a pair of electrodes, wherein the layers are stacked such that a threshold of a voltage required for coloration simply increases or decreases in a direction from a side closer to a light incident side to a side farther from the light incident side, or such that the cut-off frequency simply increases or decreases in a direction from a side closer to the light incident side to a side farther from the light incident side;
applying a layer select voltage to the pair of electrodes so as to cause a selected one of the plurality of electrochromic recording layers to become colored; and
irradiating the multi-layered optical recording medium with light so as to read information in the selected recording layer.

15. The information reproduction method according to claim 14, wherein the layer select voltage is a DC voltage of which the application time is controlled.

16. The information reproduction method according to claim 14, wherein the layer select voltage is a DC voltage of which the voltage value is controlled.

17. The information reproduction method according to claim 14, wherein the layer select voltage is an AC voltage of which the amplitude value with an offset placed on top is controlled.

18. The information reproduction method according to claim 14, wherein the layer select voltage is an AC voltage of which the frequency is controlled.

19. The information reproduction method according to claim 14, wherein the layer select voltage is determined by a combination of two or more of a DC voltage of which the application time is controlled, a DC voltage of which the voltage value is controlled, an AC voltage of which the amplitude value is controlled, and an AC voltage of which the frequency is controlled.
